(19) United States
(12) Patent Application Publication
(10) Pub. No.: US 2011/0299028 A1
(43) Pub. Date: Dec. 8, 2011

(54) METHOD OF MAKING A SOFT CONTACT LENS

(76) Inventor: John Clamp, Bedfordshire (GB)

(21) Appl. No.: 12/739,030

(22) PCT Filed: Oct. 24, 2008
(86) PCT No.: PCT/GB08/50993

§ 371 Date: Aug. 18, 2011

(30) Foreign Application Priority Data
Oct. 25, 2007 (GB) 0720965.3

(51) Int. Cl. G02C 7/04

(52) U.S. Cl. 351/160 R; 351/177

(57) ABSTRACT

Disclosed is a method of designing a soft contact lens to correct a visual defect in the eye of a human subject caused by abnormal corneal topography, the method comprising the steps of: (a) defining the posterior topography of the lens over at least a central optic zone to conform to that of the subject's cornea as previously determined; (b) defining the posterior topography of the lens over an outer portion to provide a flatter curve than that of the cornea, whilst retaining the previously defined topography over the central optic zone of the lens; (c) using empirical or theoretical data to predict or model the path of light rays passing from the cornea into the contact lens, and thereby adapting the topography of the anterior surface of the contact lens, over at least the central optic zone, to cause the light rays passing through the lens to conform to a desired wavefront (typically planar); and (d) defining the anterior surface of the contact lens over the outer portion to join the anterior optic zone to the posterior outer portion, the anterior surface over the outer portion conveniently comprising one or more thickened regions to confer rotational and/or translational stability on the lens in ocula.

### FIELD OF THE INVENTION

This invention relates to an improved method of making a soft contact lens especially, but not exclusively, a soft contact lens to correct defects in vision arising from keratoconus.

### BACKGROUND OF THE INVENTION

Defects in vision include myopia, hypermetropia and astigmatism. These are all very common defects amongst humans, and are readily correctable by spectacles or contact lenses, which may be “rigid” or “soft”. Rigid contact lenses have a water content of less than 5%, whilst soft contact lenses generally have a water content of 20% or more.

Defects in human vision may also arise from other causes including: corneal transplants, accident, and keratoconus. The latter condition is characterised by a localised thinning of the cornea, which leads to outward bulging of the cornea due to the pressure exerted thereon by the fluid between the cornea and the lens of the eye. This bulging of the cornea causes it to depart from the ideal asphericity, and so causes defective vision.

Keratoconic visual defects cannot be satisfactorily corrected by spectacles. Contact lenses have been used to help patients suffering from reduced visual acuity due to abnormal corneal surfaces caused by diseases such as keratoconus, post-operative corneal trauma and accidental corneal trauma. Typically the type of contact lens used is a Rigid Gas Permeable (RGP) contact lens.

The conventional method of utilisation of these contact lenses is to bridge over the distortions of the cornea, allowing the tears to fill voids between the lens and cornea. The refractive index of the tear is considered, by conventional wisdom, to be similar to, but not exactly the same as, both the front of the cornea and the contact lens. It is considered that this optical interaction is not relevant in improving the patient's vision. The anterior surface of the contact lens replaces the front of the cornea and becomes the main refractive element of the patient's eye. It is therefore important that this surface remains optically well defined.

This conventional method therefore relies on a contact lens being rigid enough to support itself over the distortions of the cornea, resisting the capillary forces of the tear layer, and not allowing these distortions to be transferred to the front surface of the contact lens. Therefore RGP contact lenses are mainly used to ensure that the lens retains its form on the eye.

However, the requirement that the contact lens needs to be rigid, coupled with the abnormal distortion of the cornea, means that the fitting of such rigid lenses for subjects of this sort is extremely difficult. The contact lens fitter is faced with sometimes insurmountable conflicting requirements of: (1) achieving good optical performance, (2) reducing the traumatic effects of the contact lens, and (3) providing a solution to the patient that is tolerably comfortable.

To achieve this fit, it is typical for the contact lens fitter to use many trial lenses to review the fit and repeat order a number of specialist lenses from contact lens manufacturers.

The present invention has, as one object, the provision of a method of making a soft contact lens to correct a defect in vision arising from a corneal transplant, accident or, especially, keratoconus. In a preferred embodiment, the invention provides a soft contact lens, and a method of making the same, which is able to substantially satisfy the three conflicting criteria noted above, without obliging practitioners to trial many different lenses for the subject.

U.S. Pat. No. 6,305,802 B1 describes a process by which topography and aberrometry are used to create an improved soft contact lens, however the document teaches that: “In the case of a uniquely matched contact lens back surface the unique back surface design also corrects for the primary and the higher order optical aberrations of the cornea.” This does not take into account the refractive index difference between the transitions of cornea (n=1.377), tear layer (n=1.336) and contact lens material (n=1.42 to 1.5 dependent on material). Whilst the some of the primary and higher order optical aberrations are corrected, certainly not all of the aberrations are corrected using this method.

Additionally, U.S. Pat. No. 6,305,802 B1 simply assumes the subtraction and addition of the optical aberrations for determining the anterior and/or the posterior surfaces of the contact lens, and the method is not described sufficiently to enable the production of such a contact lens.

Further, U.S. Pat. No. 6,305,802 B1 does not describe a method of optical optimisation over a series of contact lens movements on eye: it is required that a soft contact lens moves by at least 0.25 mm in translation, in order to aid the movement of tears under the contact lens and therefore provide healthy environment for the corneal tissue. Further, state of the art stabilisation methods allow for a rotational movement of 5 degrees.

### SUMMARY OF THE INVENTION

In a first aspect the invention provides a method of designing a soft contact lens to correct a visual defect in the eye of a human subject caused by abnormal corneal topography, the method comprising the steps of:

(a) defining the posterior topography of the lens over at least a central optic zone to conform to that of the subject's cornea;

(b) defining the posterior topography of the lens over an outer portion to provide a flatter curve than that of the cornea, whilst retaining the previously defined topography over the central optic zone of the lens;

(c) using empirical or theoretical data to predict the path of light rays passing from the cornea into the contact lens, and thereby adapting the topography of the anterior surface of the contact lens over at least the central optic zone to cause the light rays passing through the lens to conform to a desired wavefront (typically planar); and

defining the anterior surface of the contact lens over the outer portion to join the anterior optic zone to the posterior outer portion, the anterior surface over the outer portion conveniently comprising one or more thickened regions to confer rotational and/or translational stability on the lens in ocula.

The invention also provides a method of making a contact lens, the method comprising the steps of: designing the lens in accordance with method steps (a)-(d) defined above; and (e) manufacturing the lens according to the determined design requirements

For the purposes of the present specification, “abnormal corneal topography” refers to defects arising from corneal transplant, accident or keratoconus, but excludes astigmatism and other relatively common defects such as myopia and hypermetropia.

The “central optic zone” is that portion of the contact lens which, in normal use, is located in front of the subject's pupil and through which passes nearly all the light which is used to form an image on the subject's retina. Typically the central optic zone is a circular region of about 7.5 to 9.0 mm in diameter.

The outer portion of the lens is that part of the lens outside (i.e. peripheral to) the central optic zone. It is generally an area of thick/thin zones and with a radial dimension of about 1 to 5 mm, such that the total diameter of the contact lens (i.e. the central optic zone plus the outer portion) is typically about 11 to 17.5 mm.

Determination of the subject's corneal topography, which is a precursor to the method steps of the invention, may be conveniently accomplished by an optometrist using a corneal topographer, which instrument is now widely available commercially. These work by shining a regular pattern of lines or circles onto the cornea (typically, concentric circles). Image analysis software then analyses the resulting image by measuring the distortions created in the pattern by irregularities in the curvature of the cornea to ascertain the corneal topography.

In step (a) the posterior topography of the contact lens (ie. that surface in contact with the cornea) is selected, over at least the central optic zone, so as essentially to match that of the cornea as previously determined. The anterior topography of the lens is selected so as to provide the desired vision correction in the central optic zone, and including one or more stabilising features in the outer portion of the anterior surface. These are well-known to those skilled in the art, and typically take the form of a prism or wedge-shaped feature. Since these stabilising features might interfere with the subject's vision, they are placed outside that portion of the lens (the central “optic zone”) through which light normally enters the pupil.

The outer portion of the posterior topography of the contact lens can be modelled on the topography of the subject's cornea or, to varying extents, may be based on more generic information including, for example, the age of the subject and the horizontal visual iris diameter (HVID), whilst still giving a good fit to the subject's cornea.

In step (b), the curvature of at least the outer portion of the lens (i.e. that portion outside the central optic zone) is flattened, relative to that of the cornea of the subject's eye, whilst the topography determined for the central optic zone is left wholly or substantially unchanged. The purpose of this flattening of the curvature of the lens, relative to the cornea, is to prevent the lens being sucked against the cornea due to adhesion, and to control the level of movement of the lens on the eye. Typically, the curvature of the lens is flattened by an amount to given an axial deviation from the defined topography of the cornea, limbal area and sclera in the range of 0.05 to 0.4 mm, preferably in the range of 0.2-0.3 mm.

In order to define the posterior contact lens surface from the defined topography of the cornea, limbal area and sclera, a number of different adjustment curves are defined for controlling the amount of contact lens movement when placed on eye. Initially the standard curve is used (see FIG. 1). The posterior surface of the contact lens is then adjusted by adding the axial adjustment curve for each radial distance from the optical axis.

A wavefront is defined in order to determine the anterior surface of the contact lens. Suitable approaches include direct measurement using an aberrometer, or calculation using sphere and cylinder refraction details (e.g. from a standard eye test) to derive coefficients for defocus, prism and astigmatism. Additionally a portion of the coma coefficients determined from the measured topography, calculated from the topography map, may be used to create the wavefront.

The calculation method to determine the defocus, prism and astigmatic coefficients from sphere and cylinder refraction details may conveniently comprise, but is not limited to, creating a wavefront using a bi-conic toric equation and representing this equation as a series of points, fitting the series of Zernike equations to the set of points and using a method of least squares to determine the individual Zernike coefficients.

The calculation method to determine the coma coefficients from the topography map preferably comprises, but is not limited to, representing the topography as a series of points, fitting the series of Zernike equations to the set of points and using a method of least squares to determine the individual Zernike coefficients.

The wavefront is refracted back through the anterior surface of the cornea, into the corneal tissue, in preparation for step (c). The method advantageously comprises, but is not limited to, initially converting the series of points from which to topography is defined into a series of bi-cubic surfaces, determining the slopes at each point as a series of simultaneous equations so that the surface is continuous to the second order and refracting the wavefront into the cornea using the derivates of the bi-cubic surface to recreate the wavefront.

In step (c), the method is preferably adapted to take account of the slight refraction which takes place when the light passes from the cornea into the tear layer, and again when passing from the tear layer into the contact lens. Although the refractive indices of these materials are similar, they are not identical, so by definition some refraction must occur. The inventor believes that, contrary to accepted understanding, this may have a significant impact on visual acuity.

The anterior optical surface of the contact lens is defined at a distance from the posterior surface along the optical axis, typically 0.10 mm to 0.25 mm, and progressively built by determining the surface normals so that light transferred from the posterior contact lens surface is refracted into a desired wavefront (typically planar), and creating the anterior surface thereof by using an integration method such as Rung Kutta, to position surface facets whilst retaining the correct surface normals.

Advantageously, but not necessarily, the method of the invention can be optimised to allow for limited movement of the contact lens in ocula. For example the light ray modelling in step (c) may be repeated, using different rotation and/or translational positions for the contact lens relative to the cornea. The results can then be used to model the wavefront RMS (um) for the resulting higher order aberrations (arising as a consequence of the movement of the contact lens) and redesign or optimise the anterior topography of the lens over the central optic zone to reduce the amount of defocus that occurs. Preferably greater weight is given to those measurements in which the lens is displaced (rotationally or translationally) by small amounts (e.g. by 0.1 mm or so) from the intended position on the cornea.

The axial deviation factor used in step (b) may then adjusted as per the graph below for the determined RMS (urn HOA) value.

| RMS (um HOA) | 0.113 | 0.226 | 0.339 | 0.452 | 0.565 | 0.678 |
|---|---|---|---|---|---|---|
| Axial | 0.4 | 0.4 | | | | |
| Deviation | 0.3 | 0.3 | 0.3 | 0.3 | | |
| Factor (mm) | 0.2 | 0.2 | 0.2 | 0.2 | 0.2 | 0.2 |
| | 0.1 | 0.1 | 0.1 | 0.1 | 0.1 | 0.1 |

Axial deviation curves corresponding to the factors of 0.25 mm, 0.40 mm and 0.10 mm are shown in FIGS. 1, 2 and 3 respectively.

Typically a lens is manufactured according to the requirements determined in steps (a)-(d). The actual manufacture of the lens can be accomplished using conventional soft lens manufacture techniques, such as casting or cutting with CNC lathe equipment.

The method of the invention provides advantages over the prior art. In particular, the invention allows the provision of a contact lens that fits very well, is comfortable for the wearer and yet provides optimal or near optimal correction of visual defects.

In a third aspect, the invention provides a soft contact lens to correct visual defects in the eye of a human subject caused by abnormal topography, the lens comprising a posterior surface which, over a central optic zone, is defined to conform to the topography of the subject's cornea and which posterior surface, over an outer portion, has a curvature flatter than that of the subject's cornea, the lens further comprising an anterior surface having a topography which, over at least the central optic zone, is adapted to cause light rays passing through the lens from posterior surface to emerge from the anterior surface to conform to a desired wavefront, and wherein an outer portion of the anterior surface comprises one or more thickened regions to confer rotational and/or translational stability on the lens in ocula.

Conveniently, the lens is designed by the method of the first aspect of the invention and/or manufactured by the method of the second aspect. In a preferred embodiment, the lens is configured and adapted to correct a visual defect arising from keratoconus, corneal transplant, or accidental damage to the cornea.

The invention will now be further described by way of illustrative example, in which a contact lens is specifically manufactured for an eye exhibiting keratoconus, and with reference to the accompanying drawings, in which:

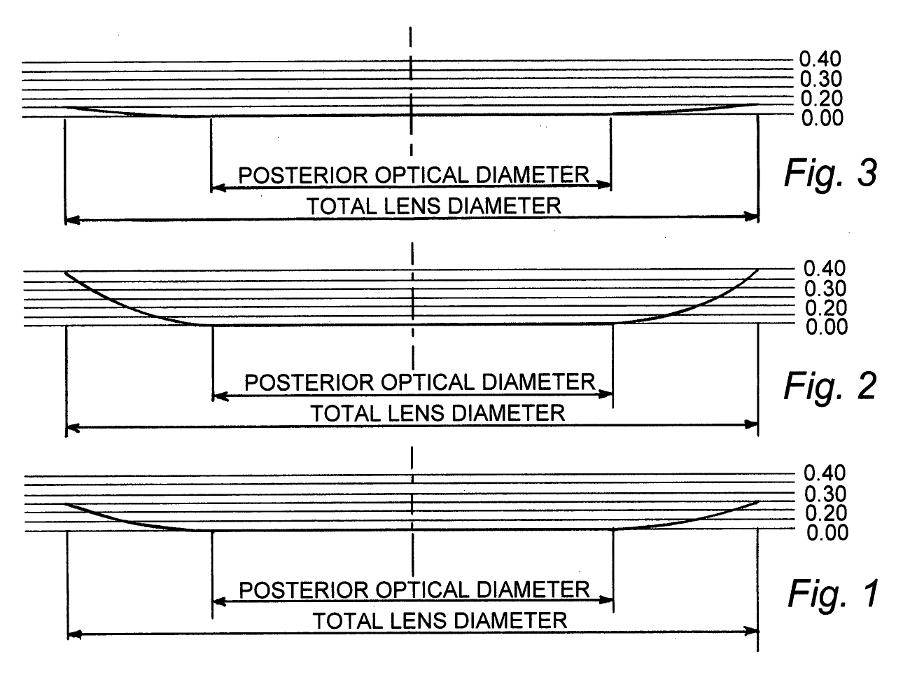

FIGS. 1-3 are schematic diagrams showing lenses with axial deviation curves corresponding to factors of 0.25 mm, 0.40 mm and 0.10 mm respectively; FIG. 1 shows the normal axial adjustment curve, FIG. 2 shows a curve allowing for greater lens movement than normal and FIG. 3 shows the curve allowing for less lens movement than normal:

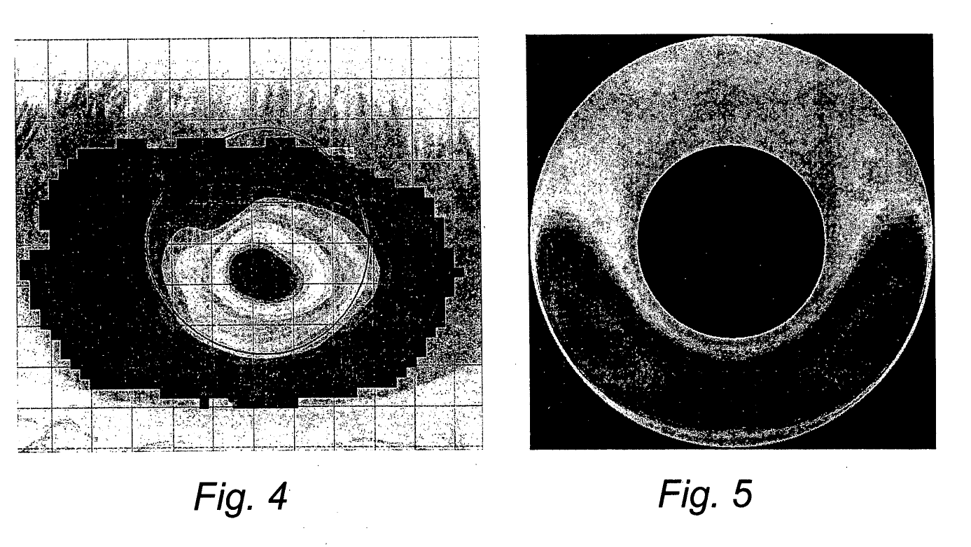

FIG. 4 is a tangential power map, showing an inferior cone typical of the eye disease keratoconus;

FIG. 5 illustrates where areas of thickness are introduced in a lens in accordance with the invention, wherein the contours depict areas of differing radial peripheral thickness to control contact lens movement; and

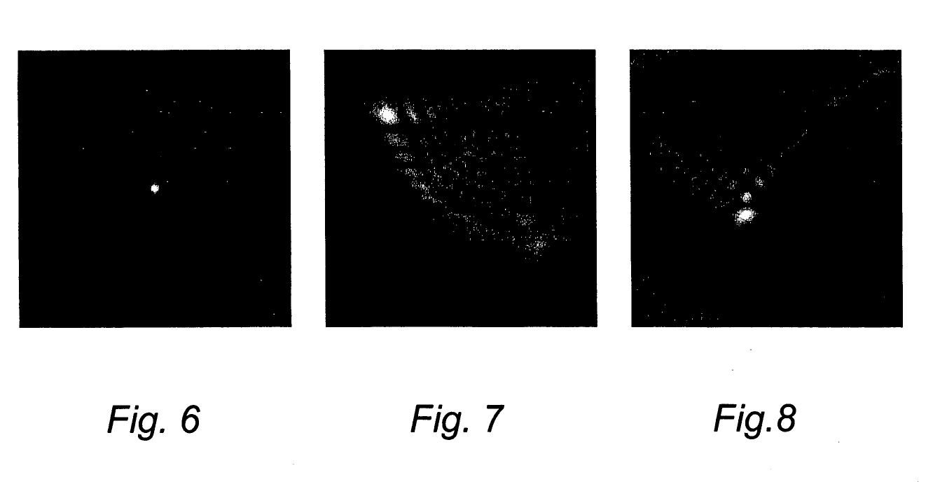

FIGS. 6-8 show the theoretical point spread functions (PSF) and associated equivalent defocus values for mis-location movements in situ for a contact lens made by the method of the invention—FIG. 6 illustrates no, mis-location, FIG. 7 the results for a 0.20 mm horizontal translational mis-location, and FIG. 8 the results for a 10 degree rotational mis-lcation.

### EXAMPLE 1

As a precursor the this example, the topography of a keratoconus eye for a specific subject was taken using a Medmont E300 topgrapher and transferred into the computer optical modelling system via the export facility of the Medmont topographer with the file extension “.muf”. The topography image displaying tangential power map (FIG. 4) clearly shows an inferior cone typical of the eye disease keratoconus.

The optic portion of the posterior surface of the contact lens was defined using the “.muf” file in terms of polar coordinates, sagittal displacement in the direction of the optical axis and differential terms in polar coordinates. In order to fully define the whole optical surface, determined to a diameter of 8.00 mm, the topography of the surface was extrapolated where necessary to the defined optical diameter using Bezier surface patches.

In order to fulfil step (b), the corneal map was extended into the limbal and scleral region using a tangential flattening limbal region of 1.0 mm width leading through to the scleral region, based on sphere of 24 mm diameter. The posterior of the contact lens was then initially defined using this corneal map. The axial adjustment curve with total axial deviation of 0.25 mm was then applied to all polar axes of the posterior surface of the contact lens.

The optical wavefront was represented using positional and first order derivatives in polar coordinates (r,φ) from the optical axis and values in Z derived from the optical refraction and the coma component obtained from the topography data. In this instance, the optical refraction was −0.50/−0.75×80, compensated to coincide with the plane perpendicular to the optical axis and coincident with the apex of the cornea, with a contribution from horizontal coma of 3.906 um.

Rays were then determined from the wavefront derivatives and sent back through the cornea, allowing refraction between air and corneal tissue, in this instance defined as having a refractive index of 1.377.

Once within the cornea, the rays were taken back out from the anterior surface of the cornea into the posterior surface of the contact lens, allowing for a refraction process to take place.

The normal plane of the anterior surface for each passing ray was determined such that the resultant rays form a wavefront that is planar. The normal planes were positioned using an iterative Runge Kutta integration method in such a way as to form a fully faceted continuous surface, seeded from the central point referenced along the optical axis at, in this example, 0.100 mm from the posterior surface of the contact lens.

A peripheral anterior surface was added to join the anterior optic portion to the posterior peripheral portion, allowing for an edge thickness of 0.15 mm. Areas of thickness were introduced to the area as per FIG. 5, wherein the contours depict areas of differing radial peripheral thickness between the posterior peripheral surface and the anterior peripheral surface.

FIGS. 6, 7 and 8 show the theoretical point spread functions (PSF) and associated equivalent defocus values for mis-location movements of the contact lens in situ.

| Mis-location | PSF | Equivalent Defocus (DS) |
|---|---|---|
| None | FIG. 6 | 0.00 |
| 0.20 horizontal translation | FIG. 7 | 0.69 |
| 10 deg Rotation | FIG. 8 | 1.13 |

The surfaces were then converted into lathe files that could be interpreted by a specialist contact lens lathe with capabilities to machines non-rotationally symmetrical geometries such as the geometries described herein. The resulting contact lens was then assessed on eye.

### Visual Acuity Results

VA for uncorrected eye 6/18

VA for eye best corrected by spectacles 6/9

VA for eye corrected using invention 6/5

1. A method of designing a soft contact lens to correct a visual defect in the eye of a human subject caused by abnormal corneal topography, the method comprising the steps of:
(a) defining the posterior topography of the lens over at least a central optic zone to conform to that of the subject's cornea as previously determined;
(b) defining the posterior topography of the lens over an outer portion to provide a flatter curve than that of the cornea, whilst retaining the previously defined topography over the central optic zone of the lens;
(c) using empirical or theoretical data to predict or model the path of light rays passing from the cornea into the contact lens, and thereby adapting the topography of the anterior surface of the contact lens, over at least the central optic zone, to cause the light rays passing through the lens to conform to a desired wavefront (typically planar);
(d) repeating the light ray modelling in step (c) using different rotational and/or translational positions for the contact lens relative to the cornea, and using the results to redesign or optimise the topography of the anterior surface of the lens to reduce the amount of defocus that occurs when the lens is in the different rotational and/or translational positions; and
(e) defining the anterior surface of the contact lens over the outer portion to join the anterior optic zone to the posterior outer portion, the anterior surface over the outer portion conveniently comprising one or more thickened regions to confer rotational and/or translational stability on the lens in ocula.

2. A method according to claim 1, wherein the topography of the subject's cornea is previously determined by a practitioner using a corneal topographer,

3. A method according to claim 1, wherein the curvature of the lens is flattened, relative to that of the subject's cornea, so as to provide an edge lift value in the range of 0.3-1.0 mm.

4. A method according to claim 3, wherein the edge lift value in the range 0.5-0.8 mm.

5. A method of making a contact lens, the method comprising the steps of: designing a contact lens in accordance with claim 1; and manufacturing the lens according to the design requirements determined in steps (a)-(e).

6. A method according to claim 5, wherein the manufacturing step comprises casting, or cutting with a CNC lathe.

7. A soft contact lens for the correction of a vision defect caused by keratoconus, and made by a method in accordance with claim 5.

8. (canceled)

9. (canceled)
